(19) United States
(12) Patent Application Publication
(10) Pub. No.: US 2006/0199070 A1
(43) Pub. Date: Sep. 7, 2006

(54) Membrane-electrode assembly, method for preparing the same, and fuel cell system comprising the same

(76) Inventors: Myoung-Ki Min, Suwon-si (KR); Hae-Kwon Yoon, Suwon-si (KR); Jan-Dee Kim, Suwon-si (KR); Hye-A Kim, Suwon-si (KR); Ho-Jin Kweon, Suwon-si (KR)

Correspondence Address: CHRISTIE, PARKER & HALE, LLP, PO BOX 7068, PASADENA, CA, 91109-7068, US

(21) Appl. No.: 11/369,610

(22) Filed: Mar. 6, 2006

(30) Foreign Application Priority Data
Mar. 7, 2005 (KR) 10-2005-0018677

(51) Int. Cl. H01M 4/94; H01M 8/10; H01M 4/90; H01M 4/92; H01M 4/88; B05D 5/12; B05D 1/02

(52) U.S. Cl. 429/44; 429/30; 427/115; 502/101; 427/427; 427/427.7

(57) ABSTRACT

The invention relates to a membrane-electrode assembly for a fuel cell, a method for preparing the same, and a fuel cell system comprising the same. The membrane-electrode assembly comprises a polymer electrolyte membrane, a catalyst layer spray-coated directly on both surfaces of the polymer electrolyte membrane; and a gas diffusion layer disposing both outer surfaces of the catalyst layer; and a method for preparing the same, and a fuel cell system comprising the same.

### CROSS REFERENCE TO RELATED APPLICATION

This application claims priority to and the benefit of Korean Patent Application No. 10-2005-0018677, filed in the Korean Intellectual Property Office on Mar. 7, 2005, the entire content of which is incorporated herein by reference.

### FIELD OF THE INVENTION

The invention relates to a membrane-electrode assembly, a method for preparing the same, and a fuel cell system comprising the same, and to a membrane-electrode assembly in which the amount of catalyst is reduced and the effect of forming a three-phase boundary is improved, a method for preparing the same, and a fuel cell system comprising the same.

### BACKGROUND OF THE INVENTION

A fuel cell is a power generation system that converts chemical energy obtained from the reaction between oxygen and hydrogen in a hydrocarbon-based material such as methanol, ethanol, and natural gas, to electrical energy.

A fuel cell can be classified as a phosphoric acid type, a molten carbonate type, a solid oxide type, a polymer electrolyte type, or an alkaline type depending on the kind of electrolyte used. Although each fuel cell basically operates in accordance with the same basic principle, the kind of fuel, the operating temperature, the catalyst, and the electrolyte may be selected depending on the type of cells.

Recently, a polymer electrolyte membrane fuel cell (PEMFC) has been developed in which the power characteristics are superior to that of conventional fuel cells, the operating temperature is lower, and the starting and response characteristics are quicker. It has several advantages in that it can be applied to a wide array of fields such as transportable electrical sources in automobiles, distributed power for houses and public buildings, and electronic devices using small electrical sources.

The polymer electrolyte fuel cell is essentially composed of a stack containing an electricity generator, a reformer, a fuel tank, and a fuel pump. The stack forms a body, and the fuel pump provides fuel stored in the fuel tank to the reformer. The reformer reforms the fuel to generate hydrogen gas and supplies the hydrogen gas to the stack.

Accordingly, the polymer electrolyte fuel cell provides fuel stored in the fuel tank to the reformer via the fuel pump. Then, the reformer reforms the fuel to generate hydrogen gas, and the hydrogen gas is electrochemically reacted with oxygen in the stack to generate electrical energy.

A different type of fuel cell is a direct oxidation fuel cell (DOFC) in which a liquid fuel is directly introduced to the stack. Examples of direct oxidation fuel cells include direct methanol fuel cells. The direct oxidation fuel cell can omit the reformer, which is essential for the polymer electrolyte fuel cell.

According to the above-mentioned fuel cell system, the electricity generator has a structure in which a plurality of unit cells, comprising a membrane electrode assembly (MEA) and a separator (or referred to as “bipolar plate”), are laminated.

The membrane electrode assembly is composed of an anode (referred to as “fuel electrode” or “oxidation electrode”) and a cathode (referred to as “air electrode” or “reduction electrode”) separated by the polymer electrolyte membrane.

The separators not only work as passageways for supplying the fuel required for the reaction to the anode and for supplying oxygen to the cathode, but also as conductors, serially connecting the anode and the cathode in the MEA.

An electrochemical oxidation reaction of the fuel occurs at the anode, and an electrochemical reduction reaction of oxygen occurs at the cathode, thereby producing electricity, heat, and water, due to the migration of electrons generated during this process.

The anode and cathode for the fuel cell generally include a catalyst layer, including a catalyst and a gas diffusion layer facilitating diffusion of the gas, and may further include a microporous layer (MPL) if required.

The catalyst generally includes Platinum (Pt), however, it is usually supported by carbon due to platinum's high cost. The catalyst layer is initially formed on the gas diffusion layer and contacted with an electrolyte membrane to provide a membrane-electrode assembly.

In order to improve the membrane-electrode assembly properties, the three-phase boundary between the catalyst, the electrolyte membrane, and the reaction gas (for example, fuel and oxidant) should be ideally formed. However, conventional membrane-electrode assemblies cause problems in that they do not provide an ideal three-phase boundary having a good contacting condition between the catalyst layer and the electrolyte membrane. Also, the catalyst layer is thicker, which increases the amount of catalyst that does not take part in the oxide/reduction reaction.

### SUMMARY OF THE INVENTION

An embodiment of the invention provides a membrane-electrode assembly in which a catalyst layer is directly coated on both surfaces of a polymer electrolyte membrane.

Another embodiment of the invention provides a method for preparing the above-mentioned membrane-electrode assembly.

Further, another embodiment of the invention provides a fuel cell system comprising the above-mentioned membrane-electrode assembly.

In one embodiment, the invention provides a membrane-electrode assembly (MEA) comprising a polymer electrolyte membrane, a catalyst layer directly spray-coated on both surfaces of the polymer electrolyte membrane, and a gas diffusion layer disposed on both surfaces of the catalyst layer.

In an embodiment, invention provides a method for preparing a membrane-electrode assembly, including moisturizing a polymer electrolyte membrane with water or a sulfuric acid aqueous solution, freezing the saturateded polymer electrolyte membrane to the temperature of 0° C. or lower, spray-coating a catalyst layer directly on both surfaces of the frozen polymer electrolyte layer below the temperature of 0° C. to provide a catalyst coated membrane (CCM), cool-pressing the CCM, and disposing a gas-diffusion layer on both surfaces of the CCM and hot-pressing the same.

In an additional embodiment, the invention further provides a fuel cell system including an electricity generating portion with a membrane-electrode assembly for the fuel cell, and a separator sandwiching both surfaces of the membrane-electrode assembly, a fuel supplier, and an oxidant supplier.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, wherein:

FIG. 1 is a cross-sectional view showing one embodiment of a membrane-electrode assembly according to the invention;

FIG. 2 is a cross-sectional view showing one embodiment of a membrane-electrode assembly according to the invention further comprising a microporous layer between the catalyst layer and the gas diffusion layer;

FIG. 3 is a schematic view showing one embodiment of the process of spraying a catalyst dispersion solution directly on both surfaces of a frozen polymer electrolyte membrane;

FIG. 4 is a schematic view showing one embodiment of the process of coating applicable to mass production;

FIG. 5 is a diagram showing a structure according to one embodiment of a fuel cell system of the invention;

FIG. 6 is an optical photograph showing a frozen polymer electrolyte membrane; and

FIG. 7 is an optical photograph showing features of the surface of a frozen polymer electrolyte membrane spray-coated with a catalyst dispersion solution.

### DETAILED DESCRIPTION OF THE INVENTION

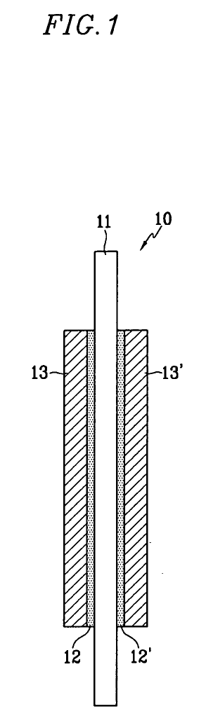

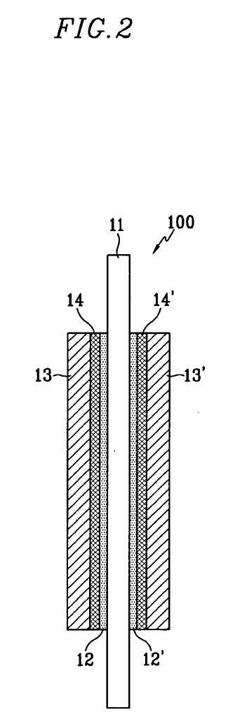

FIG. 1 is a cross-sectional view showing one embodiment of the membrane-electrode assembly according to the invention, and FIG. 2 is a cross-sectional view showing one embodiment of the membrane-electrode assembly according to the invention further comprising a microporous layer between a catalyst layer and a gas diffusion layer.

In one embodiment, referring to FIG. 1, the membrane-electrode assembly 10 includes a polymer electrolyte membrane 11, catalyst layers 12, 12′ spray-coated directly on both surfaces of the polymer electrolyte membrane 11, and gas diffusion layers 13, 13′ disposed on the outside surfaces of the catalyst layers 12, 12′. Additionally, as shown in FIG. 2, one embodiment of the membrane-electrolyte assembly 100 may further comprise microporous layers 14, 14′ between the catalyst layers 12, 12′ and the gas diffusion layers 13, 13′.

In an embodiment, the membrane-electrode assembly is formed by applying water or a sulfuric acid aqueous solution to a polymer electrolyte membrane, freezing the same, and spray-coating a catalyst layer directly on both surfaces of the frozen polymer electrolyte membrane.

Accordingly, in an embodiment, the polymer electrolyte membrane of the membrane-electrode assembly may include water or sulfuric acid and has a 60 to 100% swelling degree as shown in the following Formula 1:
Swelling degree (%)=V₁/V₂×100 Formula 1
In Formula 1, V₁ indicates volume of the microporous layer in the polymer electrolyte membrane, and V₂ indicates volume of the microporous layer in a fully saturated polymer electrolyte membrane.

The term “fully saturated” in Formula 1 means a state whereby the layer is incapable of being further saturated.

The conventional polymer electrolyte membrane of the membrane-electrode assembly has a swelling degree of around 10 to 30% defined by the above formula. However, according to one embodiment, the polymer electrolyte membrane of the membrane-electrode assembly of an embodiment of the invention has a swelling degree of 60 to 100% as defined by Formula 1 since the polymer electrolyte membrane is saturated with water or a sulfuric acid aqueous solution and then frozen. Since a membrane-electrode assembly that is capable of maintaining the swelling degree within the above range contains a lot of water in the micropores of the polymer electrolyte membrane, it can be applied to a fuel cell that is operating under a low humidity or no-humidity environment. Further, the membrane-electrode assembly in an embodiment of the invention has good proton conductivity and to facilitate the forming of a three-phase boundary.

The swelling degree can be measured using an atomic force microscope (AFM).

In one embodiment, these catalyst layers, spray-coated directly on both surfaces of the membrane-electrode assembly, respectively act as a catalyst for anode generating electrons and protons by the oxidation reaction, and catalyst for a cathode where a reduction reaction generates water.

In an embodiment, the catalyst layer has a thickness of between 5 and 50 μm and preferably between 8 and 25 μm. If the thickness is more than 50 μm, a greater amount of the catalyst is required, which lowers the utilization of the catalyst. If it is less than 5 μm, the efficiency of the oxidation and reduction reaction is lowered.

In one embodiment, the catalyst layer includes at least one metal catalyst selected from the group consisting of platinum, ruthenium, osmium, a platinum-X alloy (wherein X is a metal selected from the group consisting of Fe, Co, Ni, Cu, Zn, Ga, Ti, V, Cr, Mn, Ru, Os, Sn, W, Rh, Ir, Pd, and mixtures thereof), and combinations thereof. In an embodiment, the cathode catalyst layer includes at least one metal catalyst selected from the group consisting of platinum, a platinum-Y alloy (wherein Y is at least one metal selected from the group consisting of Fe, Co, Ni, Cu, Zn, Ti, Cr, Mn, and mixtures thereof), and combinations thereof. In another embodiment, the catalyst layer for the anode includes at least one metal catalyst selected from the group consisting of platinum, a platinum-Z alloy (wherein Z is at least one metal selected from the group consisting of Cr, Sn, W, Rh, Ir, Pd, Fe, Co, and mixtures thereof), and combinations thereof.

In one embodiment, the metal catalyst can be carried by a support, and the support may include, but is not limited to, a carbon particle such as acetylene black, graphite, Vulcan-X, ketjen black, carbon nanotubes, carbon nanofibers, and carbon nanocoils, and an inorganic particulate such as alumina and silica.

Further, the polymer electrolyte membrane of the membrane-electrode assembly has proton conductivity and acts as an ion exchange membrane for transmitting the generated protons from the anode to cathode.

Accordingly, in an embodiment, the polymer electrolyte membrane includes a proton-conducting polymer selected from the group consisting of perfluoro-based polymers, benzimidazole-based polymers, ketone-based polymers, ester-based polymers, amide-based polymers, imide-based polymers, and combinations thereof. In another embodiment embodiment, at least one proton-conducting polymer may include a polymer selected from the group consisting of poly(perfluorosulfonic acid), poly(perfluorocarboxylic acid), co-polymers of tetrafluoroethylene and fluorovinylether containing sulfonic acid groups, defluorinated polyetherketone sulfides, aryl ketones, poly(2,2′-(m-phenylene)-5,5′-bibenzimidazole), poly(2,5-benzimidazole), and combinations thereof. According to the invention, a proton-conducting polymer included in a polymer electrolyte membrane for a fuel cell is not limited to these polymers.

In one embodiment, the gas diffusion layer is carbon paper or a carbon cloth disposed on the catalyst of the membrane-electrode assembly, and may facilitate the supply of a hydrogen-containing gas and an oxygen-containing gas, supplied from outside of the assembly, to facilitate formation of a three-phase boundary.

Further, an additional embodiment may include a microporous layer between the catalyst layer and the gas diffusion layer comprising a conductive material and formed with micropores the size of several μm to several tens of μm. In an embodiment, the conductive material is at least one selected from the group consisting of graphite, carbon nanotubes (CNT), fullerene, active carbon, Vulcan-X, ketjen black, carbon nanofibers, and combinations thereof.

In one embodiment, to improve the contact between the catalyst layer of the membrane-electrode assembly and the electrolyte membrane, and to save the amount of the catalyst, one may coat the catalyst layer directly onto the polymer electrolyte membrane as in the membrane-electrode assembly according to the invention.

When the polymer electrolyte membrane is directly coated with a catalyst layer according to the conventional method, the polymer electrolyte membrane suffers from swelling that is too unbalanced to provide a uniform coating. However, according to the method of preparing the membrane-electrode assembly of the invention, it is possible to provide a catalyst coated membrane (hereinafter referred as ‘CCM’) having a uniformly swollen state since a catalyst layer is coated onto a saturated, frozen polymer electrolyte layer.

According to an embodiment of the invention, a method for preparing a membrane-electrode assembly for a fuel cell includes saturating a polymer electrolyte membrane with water or a sulfuric acid aqueous solution; freezing the saturated polymer electrolyte membrane at 0° C. or below; spray-coating a catalyst layer directly on both surfaces of the frozen polymer electrolyte layer to provide a catalyst coated membrane (CCM); cool-pressing the CCM; and disposing a gas-diffusion layer on both surfaces of the CCM and hot pressing the same.

In one embodiment, the polymer electrolyte membrane includes a proton-conducting polymer which may be selected from the group consisting of perfluoro-based polymers, benzimidazole-based polymers, ketone-based polymers, ester-based polymers, amide-based polymers, imide-based polymers and combinations thereof. In an embodiment, at least one proton-conducting polymer may include a polymer selected from the group consisting of poly(perfluorosulfonic acid), poly(perfluorocarboxylic acid), co-polymers of tetrafluoroethylene and fluorovinylether containing sulfonic acid groups, defluorinated polyetherketone sulfides, aryl ketones, poly(2,2′-(m-phenylene)-5,5′-bibenzimidazole), poly(2,5-benzimidazole), and combinations thereof. According to the invention, a proton-conducting polymer included in the polymer electrolyte membrane for a fuel cell is not limited to these polymers.

In one embodiment, in order to prevent swelling of the polymer electrolyte membrane which may occur during coating it directly on the catalyst layer, the polymer electrolyte membrane is saturated with water or a sulfuric acid aqueous solution before freezing where the sulfuric acid aqueous solution has a concentration of 2M or less and preferably between 0.5 and 1 M.

In an embodiment, the saturated polymer electrolyte membrane is subjected to a freezing process at 0° C. or lower, preferably between −200° C. and 0° C., more preferably between −100° C. and 0° C., most preferably between −20° C. and −5° C. Although the lower freezing temperature is better, the cost is excessively increased when it is under −200° C.

In an embodiment, both surfaces of the frozen polymer electrolyte membrane are formed with a catalyst layer to provide a CCM in a process that includes the steps of introducing a catalyst and a proton conductive polymer solution to an organic solvent having a freezing point of 0° C. or less to disperse the catalyst, and spraying it to form a catalyst layer wherein the catalyst dispersion solution is directly sprayed to and coated on both surfaces of the frozen polymer electrolyte membrane.

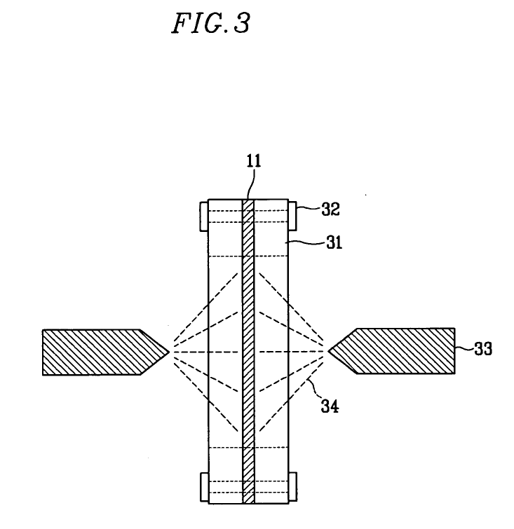

FIG. 3 is a schematic view illustrating one embodiment of the process for spraying a catalyst dispersion solution directly to both surfaces of the frozen polymer electrolyte membrane. As shown in FIG. 3, a mask 31 is disposed on both surfaces of the polymer electrolyte membrane 11 to control the shape and position of the catalyst layer, and the mask 31 is fixed by a fixing means 32 such as clamps and the like. The catalyst dispersion solution 34 sprayed from a spray nozzle 33 is coated on the polymer electrolyte membrane 11 in the figure of the mask.

Needless to say, the process for preparing the membrane-electrode assembly according to the invention is not limited to the process illustrated by FIG. 3.

In an embodiment, the spraying and coating step in the spraying process may be carried out on one surface at a time or on both surfaces of the polymer electrolyte membrane simultaneously, making it suitable for mass-production.

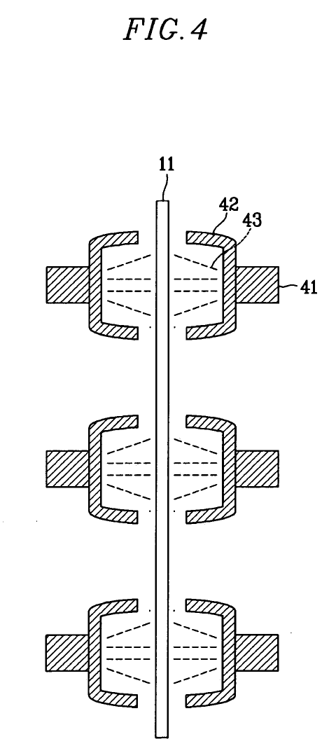

FIG. 4 is a schematic view of one embodiment of the invention showing a coating process capable of applying to the mass-production. As shown in FIG. 4, the catalyst coating process includes the steps of providing a projection 42 around the catalyst dispersion nozzle 41 to reduce the waste of the catalyst dispersion solution 43, and allotting several nozzles to each surface of the polymer electrolyte membrane 11 to carry out the spraying process of the catalyst dispersion solution 43. In another embodiment, the mass-production process shown in FIG. 4 has an advantage in that it is possible to carry out the catalyst coating process and the pressing process successively by advancing the polymer electrolyte membrane.

The process for preparing a membrane-electrode assembly according to the invention is not limited to the process illustrated in FIG. 4.

In an embodiment, the temperature during the spray process is 0° C. or lower, more preferably between −80° C. and 0° C., more preferably between −20° C. and −5° C. If the spray process is carried out at a temperature of lower than −80° C., the catalyst dispersion solution may freeze in the spray nozzle.

In one embodiment, the organic solvent for preparing the catalyst dispersion solution may include at least one selected from the group consisting of isopropylalcohol, normal-propylalcohol, ethanol, methanol, and combinations thereof.

In an embodiment, the catalyst used in forming the catalyst layer includes at least one metal catalyst selected from the group consisting of platinum, ruthenium, osmium, a platinum-X alloy (wherein X is at least one metal selected from the group consisting of Fe, Co, Ni, Cu, Zn, Ga, Ti, V, Cr, Mn, Ru, Os, Sn, W, Rh, Ir, Pd, and mixtures thereof), and combinations thereof. In an embodiment, the catalyst for the cathode includes at least one metal catalyst selected from the group consisting of platinum, a platinum-Y alloy (wherein Y is at least one metal selected from the group consisting of Fe, Co, Ni, Cu, Zn, Ti, Cr, Mn, and mixtures thereof), and combinations thereof. In one embodiment, the catalyst layer for the anode includes at least one metal catalyst selected from the group consisting of platinum, a platinum-Z alloy (wherein Z is at least one metal selected from the group consisting of Cr, Sn, W, Rh, Ir, Pd, Fe, Co, and mixtures thereof), and combinations thereof.

In one embodiment, the metal catalyst can be carried by a support where the support may include, but is not limited to, carbon particles such as acetylene black, graphite, Vulcan-X, ketjen black, carbon nanotubes, carbon nanofibers, carbon nanocoils, and an inorganic particulate such as alumina and silica.

The supported metal catalyst is commercially available or is prepared by supporting the metal catalyst using generally well-known methods, and a detailed description is omitted herein.

In one embodiment, the proton-conducting polymer solution for forming the catalyst layer may include a polymer selected from the group consisting of perfluoro-based polymers, benzimidazole-based polymers, ketone-based polymers, ester-based polymers, amide-based polymers, imide-based polymers, and combinations thereof. In another embodiment, at least one proton-conducting polymer may include a polymer selected from the group consisting of poly(perfluorosulfonic acid), poly(perfluorocarboxylic acid), co-polymers of tetrafluoroethylene and fluorovinylether containing sulfonic acid groups, defluorinated polyetherketone sulfides, aryl ketones, poly(2,2′-(m-phenylene)-5,5′-bibenzimidazole), poly(2,5-benzimidazole), and combinations thereof.

In an embodiment, the provided CCM formed with the catalyst layer is subjected to a cool-pressing process where the cool-pressing temperature is between 10 and 100° C., and more preferably between 30 and 80° C. If the cool-pressing temperature is less than 10° C., the CCM is too hard to facilitate enough binding between the catalyst layer and the polymer electrolyte layer. If it is more than 100° C., it causes deterioration of the GDL layer or the catalyst layer due to the evaporation of the frozen water.

In an embodiment, the catalyst layer of the cool-pressed CCM has a thickness of between 10 to 60 μm and preferably between 10 and 50 μm.

Then, according to an embodiment, the prepared catalyst layer is placed in contact with a gas diffusion layer, or if the surface of the gas diffusion layer has a microporous layer, the catalyst layer of the CCM is placed in contact with the microporous layer; and hot-pressed to provide a membrane-electrode assembly.

In an embodiment, the gas diffusion layer is a carbon paper or a carbon cloth and the microporous layer interposed between the catalyst layer and the gas diffusion layer may include a conductive material and may be formed with micropores of the size of several μm to several tens of μm. In one embodiment, the conductive material is at least one material selected from the group consisting of graphite, carbon nanotubes (CNT), fullerene, active carbon, Vulcan-X, ketjen black, carbon nanofibers, and combinations thereof.

Further, in an embodiment, the hot-pressing temperature is 100 to 135° C., and preferably 120 to 130° C. If the hot-pressing temperature is below 100° C., it does not facilitate adhesiveness. If it is above 135° C., it may collapse the membrane structure.

In an embodiment, the prepared membrane-electrode assembly according to the invention preferably has a swelling degree of the polymer electrolyte membrane as shown in Formula 1 of between 60 and 100%.

In one embodiment, the membrane-electrode assembly is saturated with water or a sulfuric acid aqueous solution to swell the micropores in the polymer electrolyte membrane. If the saturated polymer electrolyte membrane is frozen, the micropores are further swelled. In an embodiment, the provided swelled polymer electrolyte membrane is directly formed with the catalyst layer and pressed to provide a membrane-electrode assembly. Thereby, it can maintain the micropores in the swollen state and hold enough water. Accordingly, the membrane-electrode assembly in an embodiment of the invention is capable of operating under a low humidity or no humidity environment, and has good proton conductivity and a good effect in forming a three-phase boundary.

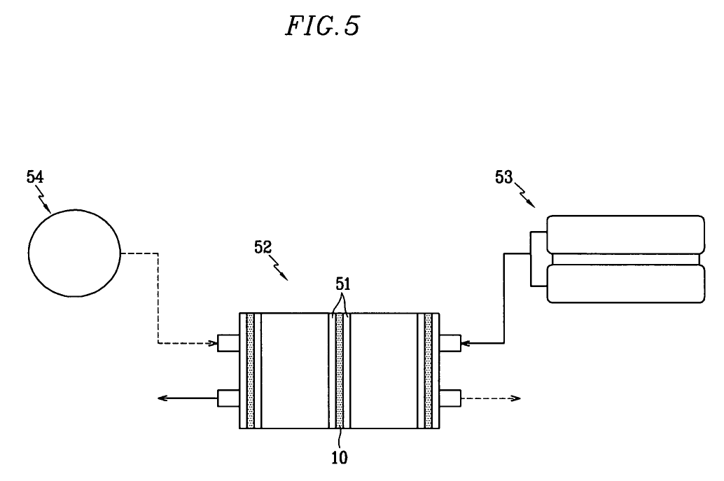

FIG. 5 is a diagram showing one embodiment of a fuel cell system according to the present invention. As shown in FIG. 5, the fuel cell system includes a) an electricity generating part 52 comprising i) the membrane-electrode assembly 10 for the fuel cell and ii) a separator 51 disposed on both surfaces of the membrane-electrode assembly, b) a fuel supplier 53, and c) an oxidant supplier 54.

In one embodiment, the fuel cell system may be applied to a polymer electrolyte fuel cell (PEMFC), preferably a direct oxidation fuel cell (DOFC), and more preferably a direct methanol fuel cell (DMFC). In an embodiment, it may further comprise a modifier to generate hydrogen gas from the hydrogen-containing fuel in a polymer electrolyte fuel cell.

The following examples further illustrate the invention in detail, but are not to be construed to limit the scope thereof.

### EXAMPLES

### Example 1

A poly(perfluorosulfonic acid) membrane (NAFION™ from DuPont) was immersed in water to be fully saturated and frozen at −10° C.

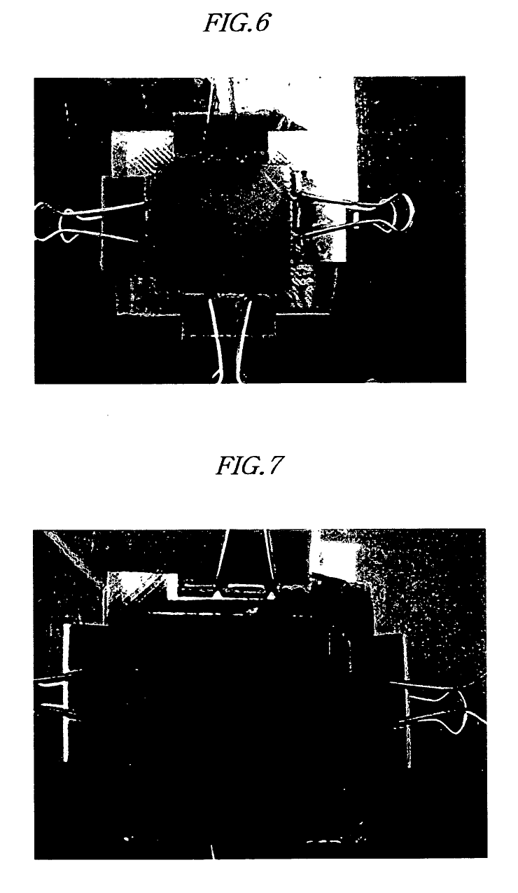

FIG. 6 is a photograph showing the frozen poly(perfluorosulfonic acid) membrane.

Further, 1 g of a platinum catalyst supported by carbon (platinum amount: 20% by weight) and 6 g of a 5% poly(perfluorosulfonic acid) solution (NAFION™ from DuPont) were mixed with 2 g of 98% isopropylalcohol (IPA), and agitated using a ultrasonic agitator and a magnetic agitator to provide a catalyst dispersion solution.

The provided catalyst dispersion solution was sprayed to both surfaces of the frozen poly(perfluorosulfonic acid) membrane at −25° C., and cool-pressed at 60° C. to provide a catalyst layer having a thickness of 15 μm.

FIG. 7 is a photograph showing the frozen poly(perfluorosulfonic acid) membrane of which the surface was spray coated with a catalyst dispersion solution.

Further, two sheets of carbon fabric formed with a microporous layer of active carbon were laminated on both outer surfaces of the catalyst layers and hot-pressed at a temperature of 130° C. to provide a membrane-electrode assembly.

### Example 2

A membrane-electrode assembly was fabricated according to the same procedure as in Example 1, except that a poly(perfluorosulfonic acid) membrane (NAFION™ from DuPont) was immersed in a 1M sulfuric acid aqueous solution. The provided membrane-electrode assembly comprised a catalyst layer with a thickness of

### Comparative Example 1

An anode layer and a cathode layer comprising a platinum catalyst were respectively formed on two sheets of carbon fabric and laminated to contact with both surfaces of a poly(perfluorosulfonic acid) membrane (NAFION™ from DuPont) to provide a membrane-electrode assembly. The provided membrane-electrode assembly included a catalyst layer having a thickness of 15 μm.

In one embodiment, the membrane-electrode assembly of the invention has catalyst layers directly formed on both surfaces of the frozen polymer electrolyte membrane such that the catalyst layers are thin and uniform. Therefore, the utilization of the catalyst is increased and an amount of the required catalyst is reduced. Further, in an embodiment, the membrane-electrode assembly has a high swelling degree of the polymer electrolyte membrane so that a large amount of water is maintained even in operation under low humidity or no humidity conditions. Since the polymer electrolyte membrane comprises water or sulfuric acid in an embodiment, it is applicable to a low humidity or a no humidity fuel cell system. The polymer electrolyte membrane is in good contact with the catalyst to facilitate provision of a three-phase boundary of the electrolyte membrane-catalyst-gas.

While the invention has been described in detail with reference to several embodiments, those skilled in the art will appreciate that various modifications and substitutions can be made thereto without departing from the spirit and scope of the invention as set forth in the appended claims.

What is claimed is:

1. A membrane-electrode assembly for a fuel cell, comprising:
a polymer electrolyte membrane;
a catalyst layer spray-coated directly on both surfaces of the polymer electrolyte membrane; and
a gas diffusion layer disposed on both surfaces of the catalyst layer.

2. The membrane-electrode assembly according to claim 1, wherein the polymer electrolyte membrane comprises a proton-conducting polymer selected from the group consisting of perfluoro-based polymers, benzimidazole-based polymers, ketone-based polymers, ester-based polymers, amide-based polymers, imide-based polymers, and combinations thereof.

3. The membrane-electrode assembly for a fuel cell according to claim 1, wherein the catalyst layer comprises at least one metal selected from the group consisting of platinum, ruthenium, osmium, a platinum-X alloy, and combinations thereof, wherein X is at least one metal selected from the group consisting of Fe, Co, Ni, Cu, Zn, Ga, Ti, V, Cr, Mn, Ru, Os, Sn, W, Rh, Ir, Pd, and mixtures thereof.

4. The membrane-electrode assembly for a fuel cell according to claim 1, further comprising a microporous layer between the catalyst layer and the gas diffusion layer.

5. The membrane-electrode assembly for a fuel cell according to claim 1, wherein the polymer electrolyte membrane has a swelling degree of between 60 and 100% defined by the following formula:
Swelling degree (%)=V₁/V₂×100
wherein V₁ indicates volume of micropores in the polymer electrolyte membrane, and V₂ indicates volume of micropores in a fully saturated polymer electrolyte membrane.

6. A method for preparing a membrane-electrode assembly for a fuel cell, comprising:
saturating both surfaces of a polymer electrolyte membrane with water or a sulfuric acid aqueous solution;
freezing the saturated polymer electrolyte membrane at a temperature of 0° C. or below;
spray-coating a catalyst layer directly on both surfaces of the frozen polymer electrolyte layer at a temperature of 0° C. or less to provide a catalyst coated membrane (CCM);
cool-pressing the CCM; and
disposing a gas-diffusion layer on both surfaces of the CCM and hot-pressing the same.

7. The method according to claim 6, wherein the polymer electrolyte membrane comprises a proton-conducting polymer selected from the group consisting of perfluoro-based polymers, benzimidazole-based polymers, ketone-based polymers, ester-based polymers, amide-based polymers, imide-based polymers, and combinations thereof.

8. The method according to claim 7, wherein the polymer electrolyte membrane comprises at least one proton-conducting polymer selected from the group consisting of poly(perfluorosulfonic acid), poly(perfluorocarboxylic acid), co-polymers of tetrafluoroethylene and fluorovinylether containing sulfonic acid groups, defluorinated polyetherketone sulfides, aryl ketones, poly(2,2′-(m-phenylene)-5,5′-bibenzimidazole), poly(2,5-benzimidazole), and combinations thereof.

9. The method according to claim 6, wherein the freezing is performed at a temperature between −200 and 0° C.

10. The method according to claim 9, wherein the freezing is performed at a temperature between −20 and −5° C.

11. The method according to claim 6, wherein the catalyst layer is formed at a temperature between −80 and 0° C.

12. The method according to claim 11, wherein the catalyst layer is formed at a temperature between −20 and −5° C.

13. The method according to claim 6, wherein the catalyst layer comprises at least one metal selected from group consisting of platinum, ruthenium, osmium, a platinum-X alloy, and combinations thereof, wherein X is at least one metal selected from the group consisting of Fe, Co, Ni, Cu, Zn, Ga, Ti, V, Cr, Mn, Ru, Os, Sn, W, Rh, Ir, Pd, and mixtures thereof.

14. The method according to claim 6, wherein the catalyst layer is formed by combining a catalyst and a proton conductive polymer solution with an organic solvent having a freezing point of 0° C. or less to disperse the catalyst to form a catalyst solution, and spraying the catalyst solution to provide the catalyst layer.

15. The method according to claim 14, wherein the organic solvent is selected from the group consisting of isopropylalcohol, normal-propylalcohol, ethanol, methanol, and combinations thereof.

16. The method according to claim 14, wherein the proton conductive polymer solution comprises a proton-conducting polymer selected from the group consisting of perfluoro-based polymers, benzimidazole-based polymers, ketone-based 10 polymers, ester-based polymers, amide-based polymers, imide-based polymers, and combinations thereof.

17. The method according to claim 6, wherein the cool-pressing is performed at a temperature between 10 and 100° C.

18. The method according to claim 17, wherein the cool-pressing is performed at a temperature between 30 and 80° C.

19. The method according to claim 6, wherein the hot-pressing is performed at a temperature between 100 and 135° C.

20. The method according to claim 19, wherein the hot-pressing is performed at a temperature between 120 and 130° C.

21. A fuel cell system comprising:
an electricity generating part including i) the membrane-electrode assembly for the fuel cell according to claim 1, and ii) a separator disposed on both surfaces of the membrane-electrode assembly;
a fuel supplier; and
an oxidant supplier.
